(19) United States
(12) Patent Application Publication
(10) Pub. No.: US 2025/0174940 A1
(43) Pub. Date: May 29, 2025

(54) Connector with Durable Locking Mechanism

(71) Applicant: Aptiv Technologies AG, Schaffhausen (CH)

(72) Inventors: Nithish SUKUMAR, Tamil Nadu (IN); Mirko POSMIK, Fürth (DE)

(21) Appl. No.: 18/961,876

(22) Filed: Nov. 27, 2024

(30) Foreign Application Priority Data
Nov. 29, 2023 (EP) 23212850.4

(51) Int. Cl. H01R 13/631; H01R 13/641

(52) U.S. Cl. CPC H01R 13/631; H01R 13/641

(57) ABSTRACT

A connector includes a housing and a locking arm designed to secure the connector to a corresponding counter connector. The locking arm is pivotable between a lock position and a release position. A linking member connects the locking arm to the housing, including a first leg attached to the housing, a second leg attached to the locking arm, and a base portion connecting the first and second legs. The linking member is configured to be flexible, allowing the legs to partially deflect, enabling the locking arm to pivot from the locked to the release position. The base portion is positioned between the first and second legs, extending from the center of the housing towards its outer side, with the first leg located farther towards the outer side than the second leg.

### CROSS-REFERENCE TO RELATED APPLICATION

This application claims the benefit of and priority to European Patent Application No. 23212850.4 filed on Nov. 29, 2023, the contents of which are incorporated by reference herein.

### TECHNICAL FIELD

The present disclosure relates to a connector, in particular to an electrical connector, which is adapted for being connected to a corresponding counter connector. The connector includes a housing and a locking arm. The locking arm is adapted for locking the connector to the corresponding counter connector. Further, the locking arm is pivotable between a lock position and a release position.

### BACKGROUND

Connectors and electrical connectors are widely known in the field. Electrical connectors are designed to connect electrical cables, wires or cable harnesses to each other, or to connect these to electrical or electronic devices. Electrical connectors usually include an insulating housing in which conductive terminals may be arranged.

For certain applications, it is important to ensure that the connectors are properly and securely mated. A primary lock system may be provided for locking the two mated connectors. The primary lock system may include a stop arranged on one of the connectors, and a locking arm with a stop arranged on the other connector. The stop of the locking arm may engage the other stop when the connectors are mated in order to lock the connectors to each other.

In addition, it is known to use a so-called connection position assurance (CPA) member which ensures the correct mating position. The CPA member may be designed such that it can only be operated when the connectors are correctly mated and locked by means of the primary lock system.

FIG. 1 illustrates an exemplary connector 1 of the prior art. The connector 1 includes a housing 2 which defines a mating direction, and which may encompass a terminal housing. The connector 1 includes a locking arm 3 to lock the connector 1 to a corresponding counter connector. Further, the connector 1 includes a CPA member 4 which is arranged movable along the mating direction of the connector 1. In the configuration illustrated in FIG. 1, the CPA member is in an open position, in which it does not block a lock release movement of the locking arm 3. In a closed position, in which the CPA member 4 is inserted further into the housing, the CPA member 4 prevents the locking arm 3 from releasing the counter connector.

FIG. 2 schematically illustrates a top view of the prior art connector 1 of FIG. 1. The locking arm 3 is linked to the connector housing 2 via two tortional hinges 5 to allow for a pivotal movement of the locking arm 3. The locking arm 3 has locking means 6 adapted for engaging the counter connector and locking the connector 1 to the counter connector, for example by means of a step feature. Further, the CPA member 4 has an actuation end 7 protruding at least partially from the housing 2. An operator can move the CPA member 4 along the mating direction, or the operator can press on the top surface of the actuation end 7 to release the primary lock: When the actuation end 7 of the CPA member 4 is pressed downwards, i.e. towards the center of the housing 2, the CPA member 4 urges the locking arm 3 to perform a pivotal movement around a pivot axis which extends through both tortional hinges 5. This pivotal movement is enabled by the tortional hinges 5 which twist during this process. In this way, the locking means 6 of the locking arm 3 is lifted to release the counter connector.

The tortional hinges 5 are a weak point in the prior art connector design. The repeated torsion or twisting of the tortional hinges 5 stresses the material and can lead to mechanical fatigue causing the tortional hinges 5 to break. This also limits the usage of advanced materials, such as e.g. fiberglass, for composing the housing. In addition, the tortional hinges 5 can prove to be unreliable in high temperature application. Increasing the overall size of the tortional hinges 5 may improve the mechanical durability thereof, but due to the also increased stiffness of enlarged tortional hinges 5, the movement of the locking arm 3 is impaired.

It is thus an object of the present disclosure to provide for an improved connector design which allows for overcoming the above deficiencies at least partially. In particular, the present disclosure aims to provide an improved connector with a reliable primary locking system, which can advantageously be used in high temperature applications.

### SUMMARY

The present disclosure provides for a connector, particularly for an electrical connector. The connector is preferably designed to be connected to a corresponding counter connector.

The connector includes a housing. The housing may have an opening into which part of the corresponding counter connector may be inserted upon mating. Alternatively, the housing may be configured for insertion into an opening of the corresponding counter connector upon mating. As will be appreciated by the skilled person, the housing may include conductive terminals for establishing an electrical connection.

The housing may encompass an area in which the electrical connection with the corresponding counter connector is established upon mating. The housing may include an insulating or dielectric material, such as polybutylene terephthalate (PBT).

The connector further includes a locking arm adapted for locking the connector to the corresponding counter connector. The locking arm may include locking means, for example a lock stop, which can engage the counter connector for locking the connector to the counter connector. The locking arm is pivotable between a lock position and a release position. Accordingly, the locking arm can be pivoted around a pivot axis such that a locking engagement of the locking arm with the counter connector can be released. In the lock position, the locking arm is in a position in which it engages the counter connector for locking the connector to the counter connector while in the release position, such a locking engagement is released. Preferably, the locking position is a relaxed position of the locking arm, and in order to reach the release position, the locking arm is deflected by applying a force. When releasing such force, the locking arm returns to the relaxed position, i.e. the locking position. The deflection may occur around a pivot axis which is preferably perpendicular to the mating direction such that the locking arm is deflecting at least partially towards the outer side of the connector. The locking arm may include the same material as the housing.

The connector further includes a linking member linking the locking arm to the housing. The linking member may support the locking arm on the housing. The linking member may be fixed to the housing via the linking member while still allowing for the pivot movement of the locking arm between the lock position and the release position. The linking member includes a first leg and a second leg and a base portion linking the first leg to the second leg. The first leg is linked to the housing, and the second leg is linked to the locking arm. Thus, the locking arm is eventually affixed to the housing via the second leg, via the base portion, and via the first leg. The base portion is affixing the first leg to the second leg in a flexible manner, such that the legs may deflect relative to one another, which allows for the pivot movement of the locking arm as described. The locking arm may include the same material as the housing.

The linking member is configured to be flexible, allowing for the two legs to at least partially deflect such that the locking arm is pivoting from the locked position to the release position. The legs, for example the free ends of the legs which are remote from the base portion, may at least partially deflect away from each other or towards each other. As the first leg is linked to the housing and the second leg is linked to the locking arm, the deflection of the legs may lead to the pivot movement of the locking arm with respect to the housing. The legs may be deflected between a rest position and a deflected position. Since the locking arm is connected to the second leg of the linking member, the position or state of the linking member may provide for a particular position of the locking arm. In the rest position, in which the legs may be parallel to each other, the locking arm may be in the lock position. In the deflected position, in which the legs may be at least partially deflected away from each other, the locking arm may be in the release position. The locking arm may include the same material as the housing.

In a direction from the center of the housing towards an outer side of the housing, the base portion is arranged between the first leg and the second leg, and the first leg is farther to the outer side than the second leg. In other words, the second leg is arranged closer to the center of the housing than the first leg, which is located further remote from the center of the housing, and the base portion is in between both legs. For example, the first leg may be arranged on the outer periphery of the housing, and the second leg may be arranged beneath the first leg such that it is covered by the first leg when orthogonally looking on the connector surface. Preferably, the direction from the inside of the housing is parallel to a plane defined by the pivotal movement of the locking arm.

According to the present invention, a flexible, secure and reliable support of the locking arm is provided, due to the advantageous design of the flexible linking member. Since the lock mechanism is less prone to material fatigue and breakage, the connector is suitable for high temperature applications. In addition, the proposed connector requires less finger actuation force in order to release the locking of the locking arm. Since tortional hinges are not required any longer to enable the pivot movement of the locking arm, fiberglass material such as fiberglass filled PBT material can be used. The connector can further be manufactured in a simple manner.

In a preferred embodiment, the linking member has an essentially U-shaped cross-section. This allows for a particularly reliable and flexible structure of the linking member. The first leg and the second leg may each define respective legs of the U-shaped cross-section, and the base portion may define connecting part between the two legs of the U-shaped cross-section. As will be understood by the skilled person, there may be a smooth transition between the legs and the base portion, particularly on the inner side of the U-shaped cross-section. This provides for a reliable and durable primary locking and release mechanism.

Further preferred, an opening of the linking member defined by the legs is facing the mating direction or the unmating direction of the connector. That is, one or both of the legs may essentially point towards the mating/unmating direction of the connector. This provides sufficient clearance for flexing the linking member such that the legs can be sufficiently deflected with reduced amount of material stress.

Preferably, the legs have an elongated shape, and the base portion has a curved shape. This allows for a secure fixation of the legs to the housing and locking arm, respectively. The curved shape of the base portion allows for a resilient form of the linking member, with reduced risk of mechanical fatigue due to repeated operation of the locking arm.

Preferably, when the linking member is in the relaxed state and the locking arm is in the locked position, the legs are essentially parallel to each other. From such a configuration, the legs can be deflected without unduly straining the base portion. When the legs are deflected, they may no longer be parallel to each other, and the base portion may be elastically deformed.

Preferably, the first leg is aligned along the mating direction of the connector. In other words, a main extension of the first leg may be parallel to the mating or unmating direction of the connector. This allows for deflecting the legs without unduly straining the base portion.

Preferably, the main extension direction of the base portion lies essentially parallel to a pivoting plane defined by the pivoting movement of the locking arm, and the pivoting plane is preferably parallel to the mating direction of the connector. The base portion may thus extend from the first leg to the second leg along a direction which is parallel to the pivoting plane of the locking arm. The pivoting plane may be defined by the pivoting movement, i.e. it may be parallel to the movement direction of the locking arm. With the base portion extending parallel to the pivoting plane of the locking arm, the base portion may only be compressed and stretched when the legs are deflected, preferably without any torsional movement. In this manner, the stability and durability of the connector and its locking mechanism is increased.

Preferably, the base portion of the linking member is adapted to elastically deform when the two legs at least partially deflect. Since the base portion connects the first leg to the second leg, deflection of the legs may cause the deformation of the base portion. The elastic deformation preferably includes a compression and/or stretching of the base portion, preferably without any torsion of the base portion. In this way, the durability of the connector and its locking mechanism is increased.

In a preferred embodiment, the connector further includes a CPA member configured movable along the mating direction and relative to the housing between an open position and a closed position. As known by the skilled person, the CPA member may ensure the correct mating connector and/or the correct locking position of the locking arm. The CPA member may be designed such that it can only be operated to move from the open position to the closed position when the locking arm is in the lock position. When the locking arm is in the lock position and the CPA member is in the closed position, a blocking abutment of the CPA member with the locking arm may prevent the locking arm from reaching the release position. Only when the CPA member has been retracted to the open position, the locking arm may be enabled to reach the release position. Providing a CPA member may increase the reliability of the connection of the connector with the counter connector.

Further preferred, the CPA member is in contact with the locking arm such that, when the CPA member is in the open position, a transversal actuation of the CPA member urges the locking arm to pivot from the locked position to the release position. An operator may press on a top surface or edge of the CPA member, preferably at one end thereof, towards the center of the housing. The CPA member may come into contact with the locking arm, directly or indirectly, and urge the locking arm to pivot from the lock position to the release position. It is thus possible to operate the locking mechanism in an easy and intuitive manner while also providing for a CPA member.

Preferably, the connector includes two linking members arranged on opposite sides of the locking arm. Accordingly, the connector may include two linking members as described herein, to link the locking arm to the housing. The pivot axis of the pivotal movement of the locking arm may extend through both linking members. Eventually, a more stable and durable configuration of the connector and the locking mechanism is provided for.

Preferably, the housing, the linking member, and the locking arm are integrally formed. The housing, the linking member, and the locking arm may thus form a single, integral part of the connector. The housing, the linking member, and the locking arm may be produced as a single component, for example by means of injection molding. This reduces the manufacturing efforts.

Preferably, the first leg is at least partially formed integrally with an outer surface of the housing. The first leg may thus be defined at least partially by the outer surface of the housing, i.e. the first leg may be a part of the outer surface of the housing. This allows for reducing the overall dimensions of the connector.

Preferably, a gap between the legs of the linking member in the relaxed state is larger than a thickness of the base portion and/or of the second leg. The gap may be measured between free end points of the legs, preferably perpendicular to the main extension direction of the first or second leg, and the thickness of the base portion and/or of the second leg may be measured in the pivoting plane. By providing a rather large gap between the legs, sufficient flexibility of the linking member can be provided for, and the force required for operating the locking mechanism of the locking arm is reduced.

Preferably, a width of the base portion of the linking member measured along the pivot axis of the locking arm is larger than a thickness of the base portion and/or of the second leg. The width may be measured in a direction parallel to the pivot axis of the locking arm, or parallel to a deflection axis of the linking member. By providing a rather wide base portion, the durability of the linking member is increased.

Preferably, at least one of the housing, the linking member, and the locking arm includes fiberglass, more preferred at least 10% fiberglass, more preferred at least 20% fiberglass, more preferred at least 30% fiberglass, more preferred at least 40% fiberglass, most preferred at least 50% fiberglass. The housing, linking member, and the locking arm may be made of fiberglass reinforced plastic. This provides for high durability, low weight, and high robustness, in addition to weather and temperature resistance.

### BRIEF DESCRIPTION OF THE DRAWINGS

FIG. 1 is an isometric view of a connector according to the prior art.

FIG. 2 is a top view of the prior art connector of FIG. 1.

FIG. 3 is an isometric view of a connector according to some embodiments.

FIG. 4 is a detailed isometric view of the connector of FIG. 3.

FIG. 5 is a detailed end view of a connector according to some embodiments.

FIG. 6 illustrates a cross-sectional view of the connector of FIG. 5.

FIGS. 7a, 7b, and 7c schematically illustrate the operation of the locking mechanism according to some embodiments.

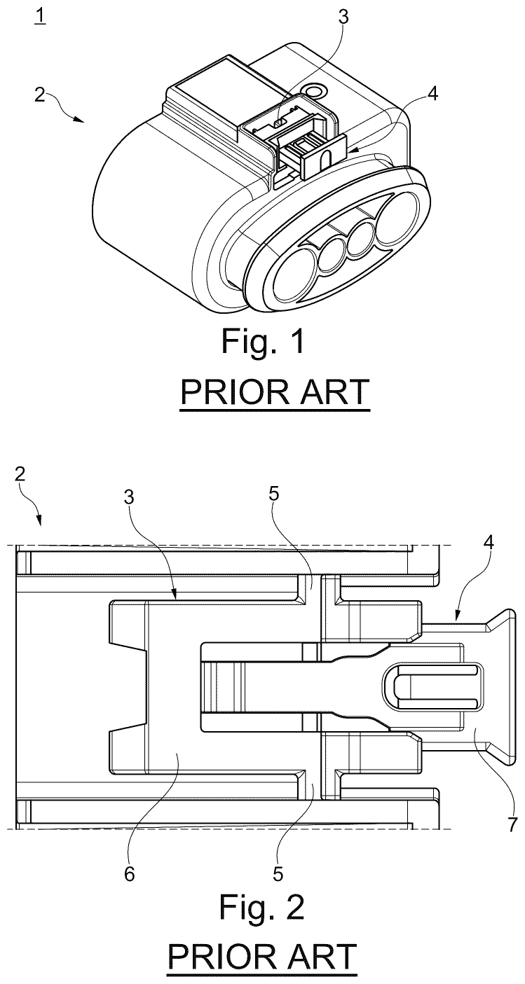

### DETAILED DESCRIPTION

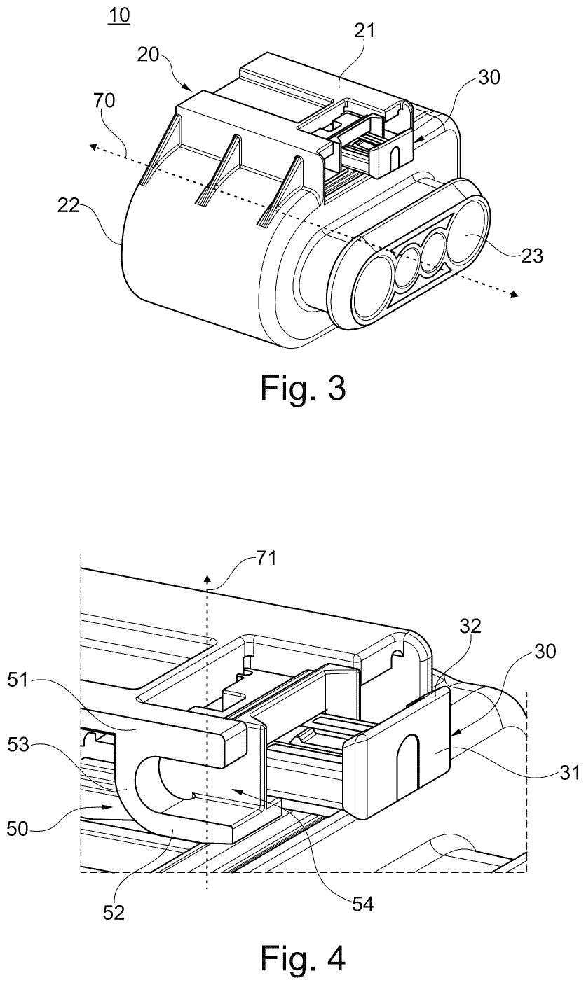

FIG. 3 illustrates a connector 10 according to an embodiment of the invention. As described herein, the connector 10 is designed to be connected to a corresponding counter connector. The connector 10 is designed as a female connector and includes a connector housing 20 which has wiring openings 23 for receiving electrical wiring or electrical terminals. The connector housing 20 further includes a mating opening 22 opposite of the wiring openings 23 which is adapted for receiving the corresponding counter connector during mating. The main axis of the mating opening 22 may define the mating and unmating directions of the connector, which is indicated by the dotted line 70. The connector can be locked to the counter connector by means of a locking mechanism with a locking arm and linking member as described herein.

The connector 10 further includes a CPA member 30 which can be moved along the mating direction 70 of the connector 10 between an open position (illustrated in FIG. 3) and a closed position, in which the CPA member 30 is inserted further into the connector housing 20. The CPA member 30 is provided in a corresponding opening provided in the housing 20, partially beneath a top surface 21 of the connector housing 20.

FIG. 4 illustrates a detailed view of the connector of FIG. 3. The CPA member 30 has an actuation surface 31 on its free end, i.e. on the end protruding from the housing 20 along the mating/unmating direction 70. The CPA member 30 further has an actuation edge 32 bordering the actuating surface 31. The actuation edge 32 is facing away from a center of the connector 10, such that it can easily be actuated by an operator for releasing the locking mechanism.

As can further be seen from FIG. 4, the connector 10 includes a linking member 50. The linking member 50 links or connects a locking arm of the connector to the housing 20, as will be described further below. The linking member 50 has a U-shaped cross-section with a first leg 51, a second leg 52, and a base portion 53 linking the first leg 51 with the second leg 52. The U-shaped cross-section defines an opening 54 facing away from the mating end of the connector 10. The first leg 51 is integrally formed with the outside surface 21 of the connector housing 20. The first leg 51 is arranged parallel to the second leg 52 when the legs are not deflected as illustrated in FIG. 4. The base portion 53 has a curved shape, providing for a smooth and step-free transition from the first leg 51 to the second leg 52, at least on the inner side of the U-shaped linking member 50, preferably also on the outer side as seen in FIG. 4. The second leg 52 is linked to a locking arm of the locking mechanism, as will be described further below.

In a direction 71 from a center of the housing towards an outer side of the housing, which is indicated in FIG. 4 by a dotted line, the base portion 53 of the linking member 50 is arranged between the first leg 51 and the second leg 52, and the first leg 51 is farther to the outer side than the second leg 52. The direction 71 indicated by the dotted line may be perpendicular to the mating direction 70 and perpendicular to a transversal direction of the connector 1, wherein the transversal direction may be parallel to a pivot axis 72 of the locking arm as described further below.

The U-shaped linking member 50 is designed flexible allowing for the two legs 51, 52 to at least partially deflect away from each other. The CPA member 30 rest on the locking arm of the locking mechanism which is linked to the second leg 52. Accordingly, when pressing onto the actuation edge 32 of the CPA member 30, thereby urging the free end of the CPA member to move towards the center of the housing 20, the second leg 52 of the U-shaped linking member 50 is urged to deflect away from the first leg 51, while the base portion 53 is elastically deforming by being stretched on its inner side.

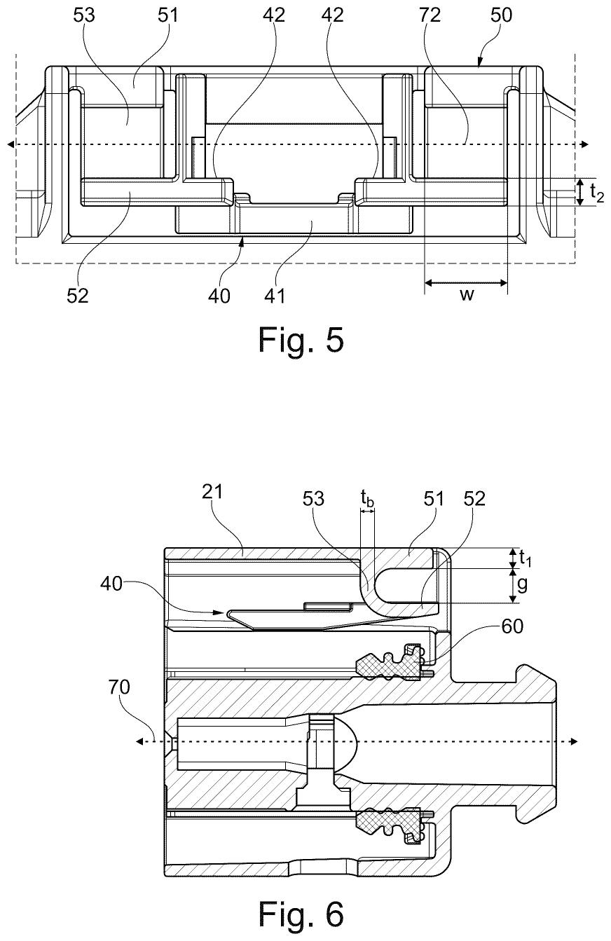

FIG. 5 illustrates a detailed view of a connector of another embodiment of the invention. FIG. 5 particularly illustrates a view of the top part of the connector of FIG. 3 along the mating direction 70 but without the CPA member. There are provided two U-shaped linking members 50 each having a first leg 51, a second leg 52, and a base portion 53 as described with regard to FIG. 3 and FIG. 4. In between the linking members 50, the CPA member 30 can generally be inserted. The first legs 51 of the U-shaped linking members 50 are integrally formed with the outer surface 21 of the housing 20. The curved base sections 53 extend from the first legs 51 to the second legs 52, which in turn are linked to the locking arm 40 of the connector 10.

The locking arm 40 includes a locking stop 41 which may come into blocking contact with a corresponding feature of the corresponding counter connector in order to lock the connectors. In the configuration illustrated in FIG. 5, the locking arm 40 is in the lock position. In a release position, in which the locking arm is pivoted such that the locking stop 41 is lifted upwards, the counter connector can be released. The locking arm 40 includes abutting surfaces 42 onto which the CPA member 30 may be positioned. The abutting surfaces 42 are linked to the second legs 52 of the U-shaped linking members 50.

When pressing onto the abutting surfaces 42, or when pressing onto the CPA member 30 positioned on the abutting surfaces 42, the abutting surfaces 42 are pushed down thereby urging the second legs 52 downwards towards the center of the housing 20, which movement is enabled by an elastic deformation of the base portions 53. This results in a pivot movement of the locking arm 40 such that the locking stop 41 of the locking arm 40 is moved upwards, i.e. away from the center of the housing 20, such that the locking arm 40 reaches the release position.

The locking arm can pivot around a pivot axis 72 which is parallel to a transversal direction of the housing, which is perpendicular to both the mating direction 70 and the direction 71 from a center of the housing towards an outer side of the housing. The pivot axis 72 may eventually be defined by the configuration and dimensions of the base portions 53 of the U-shaped linking members 50.

The width w of the base portion 53 is larger than the thickness t₂ of the second leg 52. The width may be measured along the pivot axis 72 of the locking arm 40. The thickness of the legs may be measured perpendicular to the mating direction 70 and perpendicular to the pivot axis 72 of the locking arm 40.

FIG. 6 illustrates a cross-sectional view of the connector of FIG. 5. The cross-sectional view is perpendicular to the mating direction 70, and the cross-sectional plane corresponds to the pivoting plane defined by the pivotal movement of the locking arm 40. As can also be seen in this FIG. 6, the first leg 51 is integrally formed with the top surface 21 of the housing. The base portion 53 is extending away from the first leg 51 in a direction towards the center of the housing. The inner and outer sides of the base portion 53 are curved and the base portion 53 smoothly transitions into the second leg 52, which is parallel to the top surface 21 of the housing and the first leg 51. The locking arm 40 is linked to the second leg 52 such that a deflection of the second leg 52 relative to the first leg 51 causes a reorientation of the locking arm 40. The gap g between the legs 51, 52 of the U-shaped linking member 50 in the relaxed state as illustrated in FIG. 6 is larger than the thickness t_{b} of the base portion, larger than the thickness t₁ of the first leg, and larger than the thickness t₂ of the second leg (cf. FIG. 5).

As can further be seen from FIG. 6, the connector may include additional elements such as e.g. a sealing member 60, or electrical terminals inserted into the wiring openings 23.

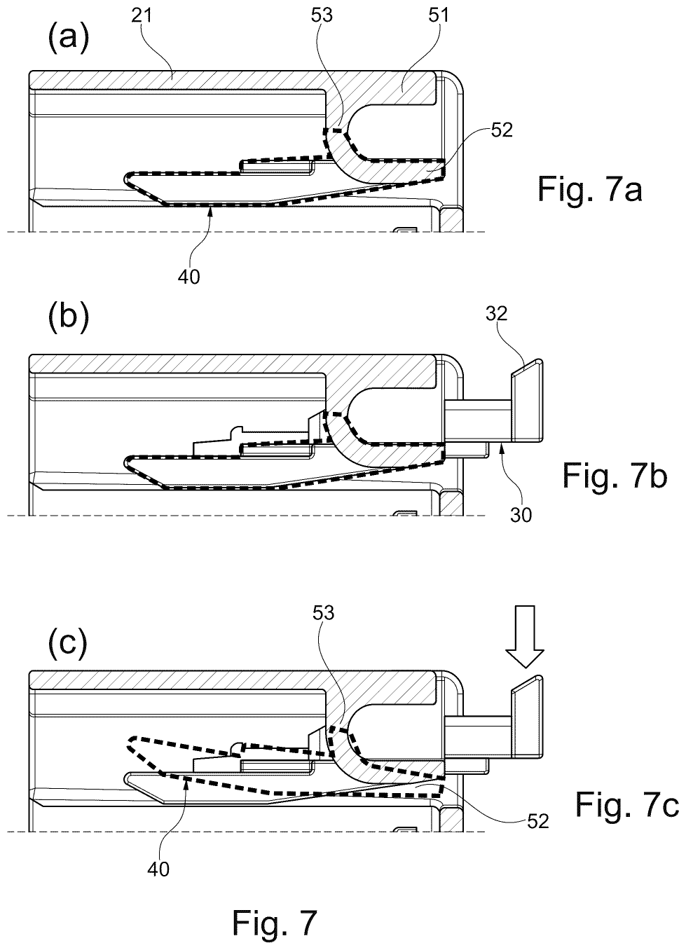

FIGS. 7a to 7c schematically illustrate the operation of the locking mechanism. In FIG. 7a, the legs 51 and 52 are parallel to each other, and the base portion 53 is in a stress-free state. The locking arm 40 is in the lock position in which it can lock the connector to the counter connector. In FIG. 7b, the CPA member 30 is inserted into the housing along the mating direction 70. The CPA member 30 rests at least partially on the locking arm 40. The locking arm 40 is still in the lock position, and the CPA member 30 is in the open position. In FIG. 7c, a force has been applied onto the actuation edge 32 of the CPA member 30 urging the CPA member 30 downwards towards the center of the connector. As a result, the base portion 53 is elastically deformed and the second arm 52 is moved downwards as well as the rear end of the locking arm 40, which is linked to the second arm 52. Due to this movement, the locking arm 40 is pivoted around the pivot axis 72, such that the part of the locking arm 40 with the locking means is lifted upwards. In this manner, the locking arm 40 reaches the release position in which the counter connector is released.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

The term “and/or” is only an association relationship describing associated objects and represents that three relationships may exist. For example, A and/or B may represent three conditions: i.e., independent existence of A, existence of both A and B and independent existence of B. In addition, the character “/” in the disclosure usually represents that previous and next associated objects form an “or” relationship.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

The invention claimed is:

1. A connector, comprising:
a housing;
a locking arm adapted for locking the connector to a corresponding counter connector and being pivotable between a lock position and a release position; and
a linking member linking the locking arm to the housing, the linking member comprising a first leg linked to the housing, a second leg linked to the locking arm, and a base portion linking the first leg to the second leg, the linking member being configured to be flexible, thereby allowing the first and second legs to at least partially deflect such that the locking arm is pivoting from the lock position to the release position, the base portion being arranged between the first leg and the second leg in a direction from a center of the housing towards an outer side of the housing and the first leg being farther to the outer side than the second leg.

2. The connector in accordance with claim 1, wherein the linking member has an essentially U-shaped cross-section.

3. The connector in accordance with claim 1, wherein an opening of the linking member defined by the first and second legs is facing a mating direction or an unmating direction of the connector.

4. The connector in accordance with claim 1, wherein the first and second legs have an elongated shape, and wherein the base portion has a curved shape.

5. The connector in accordance with claim 1, wherein, when the linking member is in a relaxed state and the locking arm is in the lock position, the first and second legs are essentially parallel to each other.

6. The connector in accordance with claim 1, wherein the first leg is aligned along a mating direction of the connector.

7. The connector in accordance with claim 1, wherein a main extension direction of the base portion is essential parallel to a pivoting plane defined by a pivot movement of the locking arm, and wherein the pivoting plane is parallel to a mating direction of the connector.

8. The connector in accordance with claim 1, wherein the base portion of the linking member is adapted to elastically deform when the first and second legs at least partially deflect.

9. The connector in accordance with claim 1, further comprising a CPA member configured movable along a mating direction and relative to the housing between an open position and a closed position.

10. The connector in accordance with claim 9, wherein the CPA member is in contact with the locking arm such that, when the CPA member is in the open position, a transversal actuation of the CPA member urges the locking arm to pivot from the lock position to the release position.

11. The connector in accordance with claim 1, wherein the connector comprises two linking members arranged on opposite sides of the locking arm.

12. The connector in accordance with claim 1, wherein the housing, the linking member and the locking arm are integrally formed.

13. The connector in accordance with claim 1, wherein the first leg is at least partially formed integrally with an outer surface of the housing.

14. The connector in accordance with claim 1, wherein a gap between the first and second legs of the linking member in a relaxed state is larger than a thickness of the base portion.

15. The connector in accordance with claim 1, wherein a gap between the first and second legs of the linking member in a relaxed state is larger than a thickness of the second leg.

16. The connector in accordance with claim 1, wherein a width of the base portion of the linking member measured along a pivot axis of the locking arm is larger than a thickness of the base portion.

17. The connector in accordance with claim 1, wherein a width of the base portion of the linking member measured along a pivot axis of the locking arm is larger than a thickness of the second leg.

18. The connector in accordance with claim 1, wherein at least one of the housing, the linking member, and the locking arm comprises fiberglass.

19. The connector in accordance with claim 18, wherein at least one of the housing, the linking member, and the locking arm comprises at least 10% fiberglass.

20. The connector in accordance with claim 1, wherein the connector is an electrical connector.
